(19) United States
(12) Patent Application Publication
(10) Pub. No.: US 2016/0091645 A1
(43) Pub. Date: Mar. 31, 2016

(54) DEAD-FRONT LENS FOR INTERIOR VEHICLE DISPLAY

(71) Applicant: Continental Automotive Systems, Inc., Auburn Hills, MI (US)

(72) Inventors: Vyacheslav B. Birman, Auburn Hills, MI (US); Jeremy J. Rooney, Waterford, MI (US); Gregory O. McConoughey, Livonia, MI (US)

(73) Assignee: CONTINENTAL AUTOMOTIVE SYSTEMS, INC., Auburn Hills, MI (US)

(21) Appl. No.: 14/501,208

(22) Filed: Sep. 30, 2014

(51) Int. Cl. G02B 5/30; G02B 1/111

(52) U.S. Cl. CPC G02B 5/305; G02B 1/111

(57) ABSTRACT

A vehicle instrument cluster lens assembly for a vehicle instruments panel includes a first layer comprised of a quarter-wave plate (λ/4). A second layer which is a polarizer, a third layer of another quarter-wave plate (λ/4); the first and a fourth layer being a polarizer light to a new orientation. The quarter-wave plates change the orientation of the light angle that it can be seen with a polarized eye glass lens. The vehicle lens assembly functions in a dual manner depending on the light source direction and orientation of the light to prevent light emitted from the instrument as well as making the display light visible to viewers wearing polarized sunglasses.

### FIELD OF THE INVENTION

The present invention relates to so called “dead front” type displays for a vehicle.

### BACKGROUND OF THE INVENTION

This invention relates to vehicle displays and, more particularly, to a vehicle lens assembly having a polarizer and a light retarder for reducing vehicle occupant glare and improving visibility.

Vehicle displays, such as instrument clusters having a speedometer and a tachometer instrument, typically display important information to the occupants of the vehicle. Conventional vehicle displays typically include a housing that supports a circuit board. One or more light sources are typically mounted on the circuit board to illuminate a display surface within the housing, to power the instruments, and to illuminate the instruments. A clear, transparent lens is mounted on the front of the housing between the vehicles occupants and the illuminated display surface to protect the display surface and instruments

Selected vehicle displays utilize a smoked lens mounted on the front of the housing instead of clear lens. In addition to protecting the display surface and instruments, the smoked lens provides a desirable appearance (i.e. a smoked lens effect). To produce the smoked lens effect, conventional smoked lens are heavily tinted to obscure the appearance of the instruments when the vehicle is turned off such that the instruments are only minimally visible to a vehicles occupant. When the vehicle is on, the light sources illuminate the instruments and are visible to the vehicle occupant through the smoke lens.

Generally to maximize the smoked lens effect it is desirable to prevent light from the surrounding environment from entering through the smoked lens and reflecting off of the display surface. Conventional smoked lenses allow the reflected light to be transmitted back through the smoked lens to the vehicle occupant. This may undesirably increase the visibility of the instruments when the vehicle is turned off, and diminish the smoked lens effect.

Accordingly, there is a need for a vehicle instrument cluster lens assembly that prevents light reflected off of the display surface from being transmitted back through a lens to a vehicle occupant to provide a more desirable smokes lens effect.

A common solution is to use a lens assembly with polarized sections in order to achieve the smoked lens effect to a greater degree while still allowing for a bright and visible display. Polarized lens assemblies have the unintended consequence of cutting down on the visibility of the display as well as decreasing visibility for those wearing polarized sunglasses.

Thus, a vehicle instrument cluster lens assembly which achieves the smoked lens effect without deterring the visibility of both sunglass wearing and sunglass free users of the instrument panel display is needed.

### SUMMARY OF THE INVENTION

A vehicle instrument cluster lens assembly for a vehicle instrument panel according to the present invention includes a first layer comprised of a quarter-wave plate (λ/4) which functions to change the orientation of polarized light which it receives. A second layer comprised of a polarizer which shifts incident light to a first orientation corresponding to the polarizing orientation specific to the polarizer. A third layer comprised of another quarter-wave plate (λ/4) which shifts the orientation of polarized light impinging on its surface from the first orientation to a second orientation. And a fourth layer comprised of a polarizer to linearly polarize light to a new orientation. The polarizers reduce the intensity of the light that passes through them depending on the orientation of the initial light when it impinges on the surface. The quarter-wave plates change the orientation of the light for specific wavelengths.

In one embodiment, the vehicle lens assembly according to the present invention can function in a dual manner depending on the light source direction and orientation of the light to prevent light emitted from the instrument as well as making the display light visible to viewers wearing polarized sunglasses. The assembly prevents darkening of the instrument panel by emitting polarized light which is initially polarized to match the polarization orientation of the first polarizer. The light having the same orientation as the polarizer orientation passes through the polarizer unchanged and enters a quarter-wave plate. The quarter-wave plate rotates the orientation of the light to the polarizing orientation the second polarizer allowing the light emitted from the display to exit the lens assembly without a reduction of brightness. The final quarter-wave plate reorients the exiting light from the display in such a way that it is oriented to the polarizing orientation of polarized sunglasses so that the instrument display panel remains visible while wearing sunglasses with polarized lenses.

In a second embodiment, the vehicle lens assembly according to the present invention functions to reduce light reflected off of an instrument panel's metallic frame in order to provide a desirable look which does not produce a glare. The frame around the display area on the instrument panel is covered only by one section of quarter-wave plate in order that the glare from the reflection of the metal is further cut down. The lens assembly cuts down glare from reflecting light by initially polarizing incident light which impinges on the surface at a first orientation corresponding to the polarizing orientation. The light then hits the second polarizer and is polarized to a second orientation being orthogonal to the first orientation. After passing through the polarizers, the light reflects off of the metallic frame and back to the set of polarizers where it is again polarized in a similar fashion and exits the assembly at a severely reduced intensity resulting in a near zero percentage of reflected light as compared to the light that entered the assembly. This produces the smoked lens effect.

The present invention provides an instrument cluster lens assembly having two polarizers and two quarter-wave plates which function together to allow for a smokes lens effect by preventing light from reflecting off of the surface of the panel while allowing greater clarity of viewing light emitted by the instrument display panel and allowing it to be viewed by viewers wearing polarized sunglasses.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 Is a perspective view of a vehicle dashboard having and instrument panel according to the present invention

FIG. 2 is a schematic sectional view illustrating a design for a “dead front” type display for a vehicle in which the lens assembly of the present invention may be utilized in accordance with the present invention

FIG. 3 is a schematic view illustrating an instrument cluster lens assembly of the present invention showing the different parts and layers of the assembly and the display in accordance with the present invention.

FIG. 4 is a sectional view taken along line 4-4 of FIG. 3 the path of light emitted from the “dead front” display through the instrument cluster lens assembly and the various changes to the polarity of the light as it progresses through the assembly and through another lens in this case illustrative of sunglasses.

FIG. 5 is a sectional view taken along line 5-5 of FIG. 3 illustrating the path of light external to the display from the environment as it goes through the instrument cluster lens assembly and reflects off of the metal frame surrounding the display and the various changes in the polarity of the light as it progresses through the assembly.

### DETAILED DESCRIPTION OF THE PREFERRED EMBODIMENTS

The following description of the preferred embodiment(s) is merely exemplary in nature and is in no way intended to limit the invention, its application, or uses.

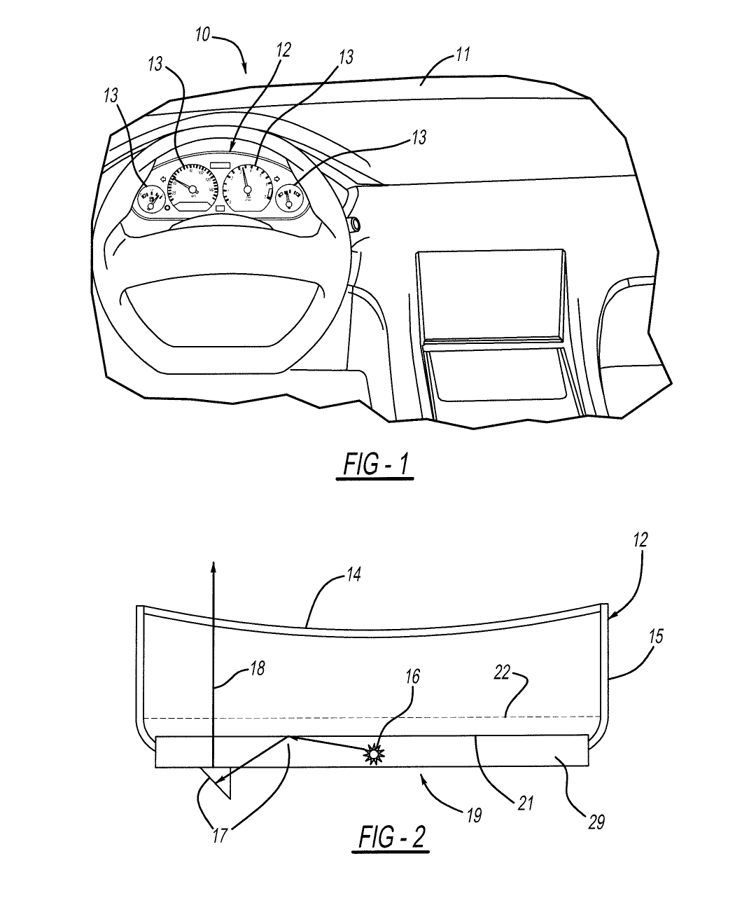

Referring now to FIG. 1 the placement of the invention in a vehicle is generally shown at 10. Typically a vehicle has a front dashboard 11 and an instrument panel 12. The present invention would be utilized in gauges 13 and or 13 which are present in the driver side of the dashboard 11.

Referring to FIG. 1, the instrument panel 12 of FIG. 1 is shown schematically and includes a housing 15 that supports a lens 14. In this example, a light guide assembly 19 located opposite from the lens 14 includes a light source 16 for illuminating the illuminable display surface 22. The light source 16 produces a display light that travels through a light guide 20, internally reflecting off of surfaces 21 of the light guide 20. A light reflector 17 within the light guide 20 receives the display light and reflects the display light out of the light guide 20 toward the lens 14.

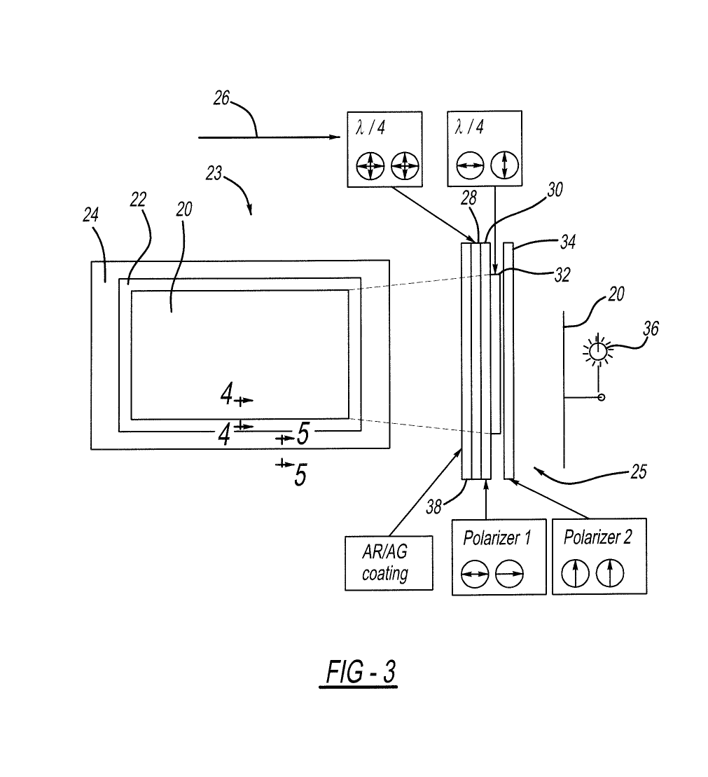

FIG. 3 illustrates the overall schematic of the instrument cluster lens assembly and the display which it covers. The display is generally shown at 23 and has components consisting of a lit LCD display section 20 a dark LCD area section 22 and a metal frame section 24, the lens assembly, generally shown at 25, covers the display 23. The lens assembly 25 includes five lenses; an AR/AG coating 38 which provides a surface to diffuse some of initial incident light immediately off of the surface without penetrating into the lens assembly; a first quarter-wave plate (λ/4) 28 which functions to rotate the orientation of polarized light; a first polarizer 30 which polarizes light to an orientation specific to the polarizing orientation of the polarizer; a second quarter-wave plate 32 which functions similarly to the first quarter-wave plate 28 in that it rotates the orientation of polarization; and, a second polarizer 34 which polarizes light impinging on its surface to a second orientation corresponding to the polarizing orientation of the polarizer. All five layers of the lens assembly 25 cover the lit display section 20 and the dark display section 22. However, it is to be appreciated that the metal frame section 24 of the assembly is covered only by a portion of the lens assembly 25. The metal frame section 24 is covered only by four layers of the assembly 25, the second quarter-wave plate 32 does not cover the metal frame 24 section for reasons that are set forth in further detail below. The path of incident light 26 from the environment through the lens assembly shows the orientation of the lens assembly, specifically that the AR/AG coating 38 is the top most layer with respect to the environment. The light display section of the panel 20, which emits light from a light source 36 that passes through the lens assembly is shown. Thus the orientation of the lens assembly, being in front of the lighted LCD display within the instrument panel is shown.

FIG. 3 of the quarter-wave plates and the polarizers in the assembly. In this example the quarter-wave plates 28 and 32 shift the orientation of polarized light by 90 degrees. The first polarizer 30 has a horizontal orientation and the second polarizer 34 has a vertical orientation. It should be understood to one ordinarily skilled in the art that the orientation of the quarter-wave plates could be oriented to shift the orientation of polarized light to any degree in order to produce an angle of polarization corresponding to those of polarized lenses in order to be seen through them.

Thus, The AR/AG coating 38 is the outermost layer, followed by the first quarter-wave plate 28, then the first polarizer 30 having a first orientation, the second quarter-wave plate 32, and the second polarizer 34 having a second orientation which differs from the first polarizer's orientation by 90 degrees.

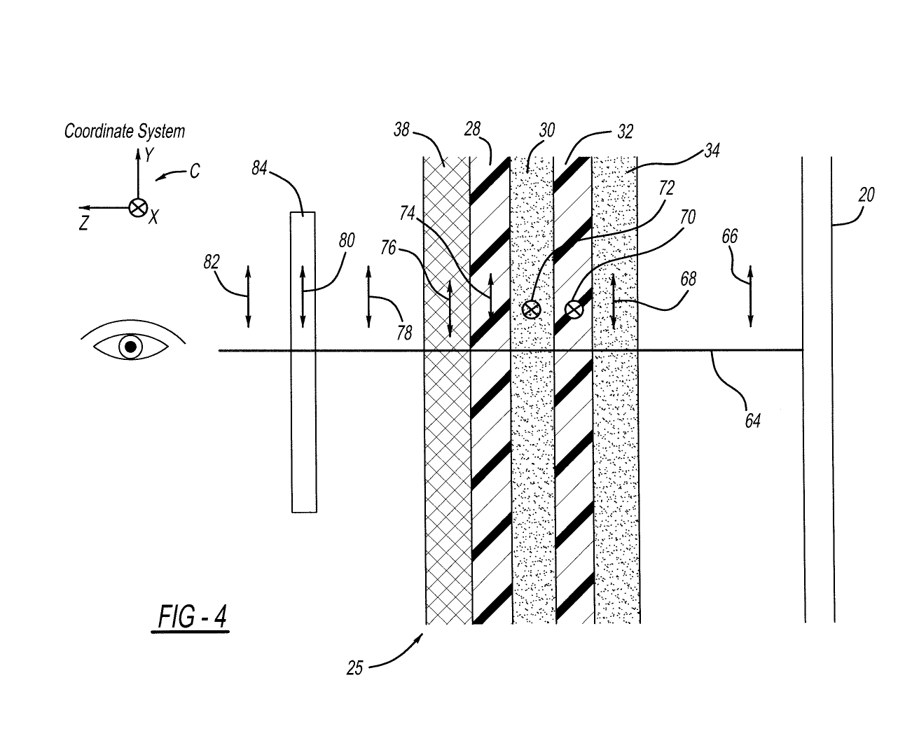

FIG. 4 illustrates the path of light 64 being emitted from the display 52 and its path and orientation through the cluster lens assembly 25 and through the lens of a polarized surface 84 representative of polarized sunglasses. The direction of propagation of the light is in the Z-direction according the coordinate system C. The light is initially emitted from the display 20 in a vertically oriented polarization as shown at 66 and in the Y-direction according to the coordinate system C. The light enters the assembly, going through the polarizer 34; the polarizer 34 having a vertical orientation does not polarize the light 68 as it is already vertically polarized when emitted from the LCD display 20 when it passes through the polarizer 34. The light then enters the second quarter-wave plate 32 and its orientation is rotated 90 degrees to a second orientation 70 now being horizontally polarized in the X-direction as indicated by the circled X symbol according to the coordinate system C but not being reduced in intensity. Being of a horizontally polarized orientation the light passes through a first polarizer 30 without being polarized as the polarizer 30 has a horizontal polarizing orientation. The light then goes through first quarter-wave plate 28 rotating its orientation by 90 degrees to a third orientation corresponding to a vertically polarized orientation 74 along the Y-direction according to the coordinate system C. The now vertically polarized light 76 passes through the AR/AG coating 38 with no effect, remaining in the same orientation 78 as it passes into open air. This vertically polarized light is visible to the naked eye and also serves to be viewable for a viewer wearing polarized sunglasses 84. Vertically oriented light 80 upon passing through polarized lenses 84 is not effected by the polarized lenses 84 and passes through them unchanged, remaining in a vertically oriented polarization 82 thus being viewable. Without polarized lenses the view of the polarized light is the same allowing for viewing with and without polarized lenses. It should be noted to one ordinarily skilled in the art that the outgoing orientation of the light need not be vertical and could be of any angle corresponding to be viewable under polarized lenses. The construction of the quarter-wave plates would therefore not be limited to shifting the orientation of light by 90 degrees but by any angle necessary.

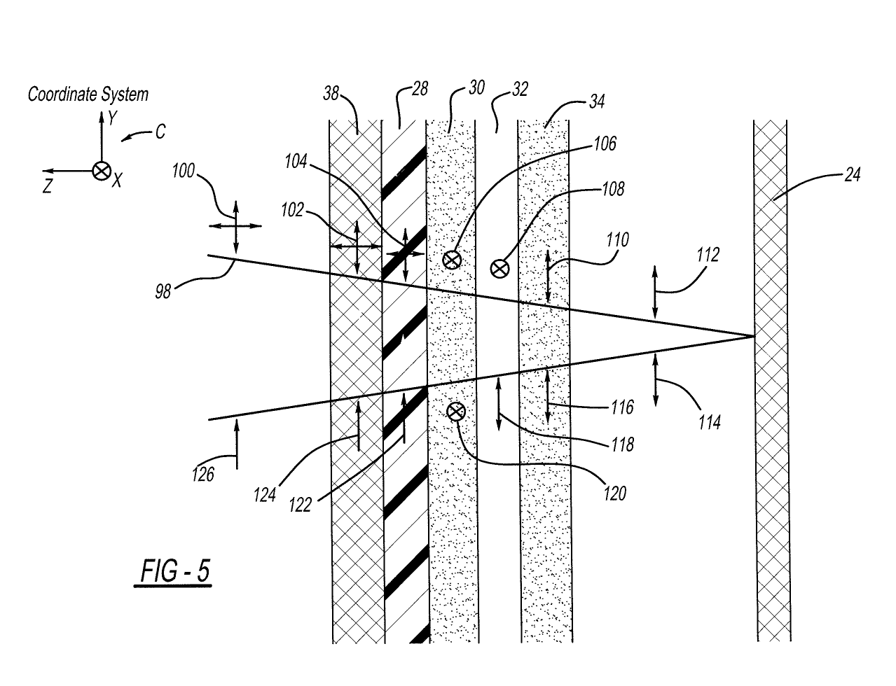

FIG. 5 illustrates the path of external light 98 as it passes from outside the assembly 25 and reflects off of the metal frame 24 of the display 23, passing again through the assembly 25. Initially unpolarized incident light 100 propagating in the Z-direction according to the coordinate axis C enters the assembly 25, first impinging upon the AR/AG coating 38 which diffuses some of the light. The light is not otherwise affected and remains unpolarized light 102 as it passes into the first quarter-wave plate 28. The quarter-wave plate 28 does not have an effect on the light as it passes through, again remaining unpolarized light 104. Upon entering the first polarizer 30 the light is polarized into a first orientation 106 corresponding to the polarizing orientation of the polarizer 30 in this case being horizontally oriented along the X-direction as designated by the circled X symbol and according to the coordinate system C and is cut down in intensity by 1/100^{th}. The light then enters an unoccupied layer 32 and remains in the same orientation 108 before entering second polarizer 34 having a second orientation corresponding to the polarizing orientation of the polarizer 34. The light having a horizontal orientation 108 upon entering the polarizer 34 is polarized to a second orientation corresponding in this example to a vertical orientation in the Y-direction according to the coordinate system C and being cut down in intensity by ½. The light exits the assembly with a vertical orientation 112 and reflects off of the metal frame 24 remaining in an unchanged orientation 114 and reenters the assembly. The light 116 reentering the polarizer 34 having the same orientation as the polarizer 34 does not become polarized and remains at the same orientation, passing through the polarizer 34 unchanged. The light passes into the unoccupied space 32 with a vertical orientation 118 in the Y-direction. The light then enters the polarizer 30 becoming polarized to a third orientation 120 corresponding to the polarizing orientation of the polarizer in this case horizontally polarized indicated by the circled X symbol and becoming reduced in intensity by a factor of 1/100^{th}. The now horizontally polarized light 120 enters the quarter-wave plate 28 and is rotated 90 degrees to a fourth orientation 122 corresponding to a vertical orientation in the Y-direction. The light enters the AR/AG coating 38 with no effect, remaining in the same orientation 124 as it passes out of the cluster lens assembly with the same orientation. The light leaves the cluster lens assembly with a vertical orientation in the Y-direction and at 0.005% of its initial intensity as shown by 126. This reduction in intensity reduces any undesirable scattering of the reflected light to imperceptible levels and reorientation provided by the quarter-wave plate 28 provides for the smoked lens effect.

FIG. 5 shows the path of light 98 as it passes through the assembly 99 and is polarized and reduced in intensity as it passes through a set of polarizers 30 and 34. It is then reflected off a metal surface 96 before passing through the set of polarizers 30 and 34 again but only being polarized once due to the corresponding orientation of the light. Any reflected light then leaves the cluster lens assembly greatly reduced in intensity allowing for barely any light being reflected off of the metal frame, such as to be un-viewable by the human eye providing a smoked lens effect. In this case the orientations of the respective polarizers and the direction of propagation of the light are orthogonal with one another according to coordinate system C.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle instrument cluster lens assembly for reducing glare which is viewable through a polarized eyeglass lens comprising:
A first layer comprised of a quarter wave plate for receiving and shifting the orientation of polarized light;
A second layer comprised of a polarizer for polarizing incident light into linearly polarized light having a first orientation that corresponds to the polarizing orientation;
A third layer comprised of a quarter wave plate for receiving polarized light and shifting the first orientation of the polarized light to a second orientation which differs from the first orientation; and,
A fourth layer comprised of a polarizer for polarizing incident light into linearly polarized light having a third orientation that corresponds to the polarizing orientation wherein light from a lighted display exiting through said assembly via said front lens is oriented for passing through a polarized eyeglass lens.

2. The assembly of claim 1 wherein said first and second orientations are selected for matching of a final orientation of polarized light which is viewable by the polarized eyeglass lens.

3. The assembly as recited in claim 2, wherein the second orientation is shifted about 90 degrees from the first orientation.

4. The assembly as recited in claim 2, wherein the third orientation is shifted about 90 degrees from the second orientation.

5. The assembly as recited in claim 2, wherein the second quarter-wave plate re-orients polarized light by 90 degrees.

6. The assembly as recited in claim 1 further comprising an anti-reflective coating on the first layer for partially reflecting incident light before the incident light impinges upon the assembly.

7. The assembly as recited in claim 6, wherein the anti-reflection layer on the first layer for reflecting at least a portion of the incident light before the incident light impinges upon the first layer.

8. The assembly as recited in claim 1, wherein the first and third layers comprise at least one of a polymer film, an inorganic layer. And a layer including mica.

9. The assembly in as recited in claim 1, wherein the polarizing orientation is linear for transforming the incident light into linearly polarized light.

10. A vehicle instrument cluster lens assembly for reducing glare, which is viewable through a polarized eyeglass lens comprising in sequence:
A quarter-wave plate for shifting orientation of polarized light by an angle corresponding to the quarter-wave plate's orientation;
A first polarizer having a polarizing orientation for transforming incident light into linearly polarized light having a first orientation;
A second quarter-wave plate for shifting the orientation of polarized light by an angle corresponding to the quarter-wave plate's orientation;
A second polarizer having a polarizing orientation orthogonal to orientation of the first polarizer for transforming light impinging on its surface to polarized light at a new second orientation corresponding to the polarizing orientation; and,
A light source for emitting display lights through the surface towards the polarizer, the surface transmitting at least a portion of the display light toward the polarizer.

11. The assembly as recited in claim 10, wherein the polarizer and quarter-wave plates act to absorb incident light without absorbing light emitted from the display.

12. The assembly as recited in claim 10, further comprising an anti-reflective coating on the outer layer of the first quarter-wave plate.

13. The assembly as recited in claim 10 wherein the assembly covers a non-reflective area where the display panel is located

14. The assembly as recited in claim 10 wherein the assembly covers a reflective metal surface.

15. The assembly as recited in claim 14 wherein the assembly does not include the second quarter-wave plate between the polarizer sections allowing for further polarization of the reflected light in an area overlapping said reflective metal surface.

16. The assembly recited in claim 10 wherein the first orientation is shifted about 90 degrees from the second orientation

17. The assembly as recited in claim 10, wherein the polarizer and quarter-wave plated are oriented so the outgoing orientation of the display light after exiting the assembly is oriented so-as to be in the same orientation as polarized sunglasses.

18. The assembly as recited in claim 14 wherein the members of the assembly are oriented so that vertically polarized light is emitted allowing viewing by vertically polarized sunglasses.

19. The assembly as recited in claim 12 wherein the polarizer comprises a polyethylene film.

20. The assembly as recited in claim 14, wherein the quarter-wave plate comprises at least one of a polymer film, an inorganic layer, and a layer including mica.

21. A vehicle instrument cluster lens assembly comprising:
A viewable LCD portion having an outer periphery which is attached to a metallic backing portion, said metallic backing portion extending beyond the outer periphery of said LCD portion forming a visually undesirable frame portion;
A said viewable LCD portion including a vehicle instrument cluster lens assembly for reducing glare comprising:
A quarter-wave plate having a construction to shift orientation of polarized light by 90 degrees;
A first polarizer having a polarizing orientation for transforming incident light into linearly polarized light having a first orientation
A second quarter-wave plate having a construction to shift the orientation of polarized light by 90 degrees;
A second polarizer having a polarizing orientation orthogonal to orientation of the first polarizer for transforming light impinging on its surface to polarized light at a new second orientation corresponding to the polarizing orientation;
A light source for emitting display lights through the surface towards the polarizer, the surface transmitting at least a portion of the display light toward the polarizer and effectively aligning light from the display in a directional orientation which is compatible for viewing with polarized glasses;
And wherein one of the quarter wave plates does not extend over the visually undesirable frame portion such that incident external light which reaches the frame portion is attenuated while twice passing through the first and second polarizer layers not transmitted back through the lens to an extent which is viewable by the human eye.

22. The assembly as recited in claim 21 wherein incident light from the environment is polarized twice upon entering the assembly and once upon leaving the assembly after being reflected off of the metal frame section.

23. The assembly as recited in claim 22 wherein each time the incident light is polarized by the first polarizer it is reduced in intensity by 1/100^{th} and each time it is polarized by the second polarizer it is reduced in intensity ½ resulting in an overall intensity of 0.005% of the original intensity.
